(19) United States
(12) Patent Application Publication
(10) Pub. No.: US 2004/0191674 A1
(43) Pub. Date: Sep. 30, 2004

(54) Chemical amplification resist composition

(76) Inventors: Yukio Hanamoto, Osaka (JP); Kouji Kuwana, Osaka (JP); Satoshi Yamamoto, Osaka (JP)

Correspondence Address: BIRCH STEWART KOLASCH & BIRCH, PO BOX 747, FALLS CHURCH, VA, 22040-0747, US

(21) Appl. No.: 10/808,515

(22) Filed: Mar. 25, 2004

(30) Foreign Application Priority Data
Mar. 28, 2003 (JP) 2003-090253
Apr. 17, 2003 (JP) 2003-102541

(51) Int. Cl. G03C 1/76

(52) U.S. Cl. 430/270.1

(57) ABSTRACT

A chemical amplification resist composition comprising a treated resin (1) obtained by contacting crude resin (1) with activated carbon, an acid generator and a solvent,

wherein resin (1) is

(a) a (meth)acrylic resin which is insoluble or poorly soluble in an alkali aqueous solution and becomes soluble in an alkali aqueous solution by the action of an acid, and

which comprises a repeating unit having an alicyclic hydrocarbon group in its side chain or

(b) a styrenic resin which is insoluble or poorly soluble in an alkali aqueous solution and becomes soluble in an alkali aqueous solution by the action of an acid, and which

comprises a repeating unit derived from hydroxystyrene, and a process for producing the same.

This nonprovisional application claims priority under 35 U.S.C. §119(a) on patent application Ser. Nos. 2003-90253 and 2003-102541 filed in JAPAN on Mar. 28, 2003 and Apr. 7, 2003, the entire contents of which are hereby incorporated by reference.

### BACKGROUND OF THE INVENTION

1. Field of the Invention

The present invention relates to a resist composition suitable for lithography and the like, acting by radiation ray of high energy such as far ultraviolet ray (including excimer laser and the like), electron beam, X ray or radiation light and the like.

2. Description of Related Art

Recently, with progress in higher integration of integrated circuits, there occurs a requirement for formation of submicron patterns. Particularly, lithography using excimer laser from krypton fluoride or argon fluoride is paid to attention since it enables production of 64 M DRAM to 1G DRAM. The so-called chemical amplification resist composition suitable for lithograph process using excimer laser basically comprises a binder unit, an acid generator and a solvent. As the binder unit, resins which is insoluble or poorly soluble in an alkali aqueous solution, and which becomes soluble in an alkali aqueous solution by the action of an acid, are generally used.

Foreign objects (i.e. minute particles derived from resins) contained in the chemical amplification resist compositions used in the production of highly integrated circuits cause defects generation in the formation of patterns. Reduction of the amount of the foreign objects in the photo resist composition is highly required.

Photo resist compositions are used as materials for microfabricated pattern formation in production of IC, LSI, or the like which are used for electronic calculators, etc.. Following higher integration of LSI, etc., the design rule of integrated circuits has changed from 0.35 μm to 0.1 μm. The photo resist composition is requested to have such ability that all the components. are completely dissolved in the solvent used and the composition have good preservation stability even after long time storage in addition to the basic performances such as resolution, sensitivity, profile, coatability, and the like.

Though finer filtration is necessary in the production of chemical amplification resist compositions, the finer filtration tends to deteriorate its production efficiency as it causes more clogs. Therefore, the chemical amplification resist composition with higher filtration speed in finer filtration is desired.

### SUMMARY OF THE INVENTION

The present invention relates to the followings:

<1> A chemical amplification resist composition comprising a treated resin (1) obtained by contacting crude resin (1) with activated carbon, an acid generator and a solvent,

wherein resin (1) is

(a) a (meth)acrylic resin which is insoluble or poorly soluble in an alkali aqueous solution and becomes soluble in an alkali aqueous solution by the action of an acid, and

which comprises a repeating unit having an alicyclic hydrocarbon group in its side chain (hereinafter referred to as “Resin (a)”) or

(b) a styrenic resin which is insoluble or poorly soluble in an alkali aqueous solution and becomes soluble in an alkali aqueous solution by the action of an acid, and which

comprises a repeating unit derived from hydroxystyrene (hereinafter referred to as “Resin (b)”).

<2> The chemical amplification resist composition according to <1>, wherein the resin (1) contains a repeating unit having acid labile group.

<3> The chemical amplification resist composition according to <2>, wherein the repeating unit having acid labile group is a repeating unit having a group dissociated by the action of an acid.

<4> The chemical amplification resist composition according to <3>, wherein the content of the repeating unit having a group dissociated by the action of an acid in the resin (1) is 10 to 80% by mol.

<5> The chemical amplification resist composition according to any one of <1> to <4>, wherein the resin (1) is Resin (a) and the repeating unit having a alicyclic hydrocarbon group in its side chain is at least one repeating unit selected from the group consisting of a repeating unit derived from 2-alkyl-2-adamantyl (meth)acrylate and a repeating unit derived from 1-(1-adamantyl)-1-alkylalkyl.

<6> The chemical amplification resist composition according to any one of <3> to <5>, wherein the repeating unit having a group dissociated by the action of an acid is a repeating unit of the formula (1)

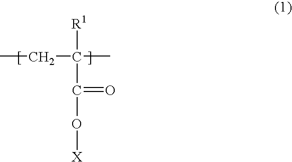

wherein R¹ represents hydrogen, methyl or trifluoromethyl, and X represents a residue of tertiary alcohol or a group represented by the formula of —CH(R²)—OR³, wherein R² represents hydrogen or C1-5 alkyl, R³ represents C1-3 alkyl, (alicyclic hydrocarbyl)oxyalkyl or (alicyclic hydrocarbyl)carbonyloxyalkyl, or R² and R³ bond to form alkylene having 5 to 10 carbon atoms wherein at least one —CH2— in the alkylene other than the —CH2— connected to the adjacent —O— may be substituted by —O—.

<7> The chemical amplification resist composition according to any one of <1> to <6> wherein the resin (1) is Resin (a) and Resin (a) further comprises at least one repeating unit selected from the group consisting of a repeating unit derived from 3-hydroxy-1-adamantyl (meth)acrylate, a repeating unit derived from 3,5-dihydroxy-1-adamantyl (meth)acrylate, a repeating unit derived from (meth)acryloyloxy-γ-butyrolactone wherein at least one hydrogen on the lactone ring may optionally be substituted by alkyl, a repeating unit of the following formula (Ia) and a repeating unit of the following formula (Ib):

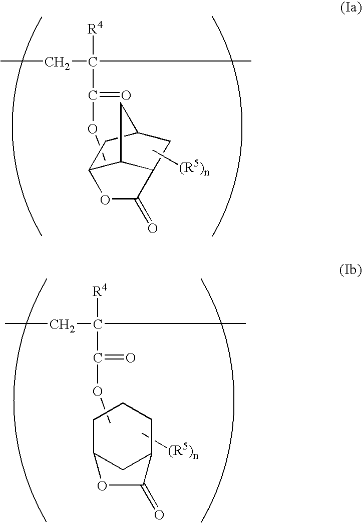

wherein R⁴ represents hydrogen, methyl or trifluoromethyl, R⁵ represents methyl or trifluoromethyl, n represents an integer of from 0 to 3, and when n is 2 or 3, each of R⁵ is the same or different.

<8> The chemical amplification resist composition according to any one of <1> to <7> wherein the resin (1) is Resin (a) and Resin (a) further comprises at least one repeating unit selected from the group consisting of a repeating unit derived from an aliphatic unsaturated dicarboxylic anhydride and a repeating unit derived from 2-norbornene.

<9> The chemical amplification resist composition according to any one of <1> to <8> wherein the resin (1) is Resin (a) and the crude Resin (a) is a resin produced by radical polymerization of a monomer having (meth)acrylic ester structure and leading to a repeating unit having an alicyclic hydrocarbon group in its side chain in an organic solvent selected from the group consisting of aromatic hydrocarbon, ether, glycol ether ester, ester, ketone and alcohol at a temperature of −50 to 100° C.

<10> The chemical amplification resist composition according to <3>, <4> or <6> wherein the resin (1) is Resin (b) and the repeating unit having a group dissociated by the action of an acid is a repeating unit of the formula (3)

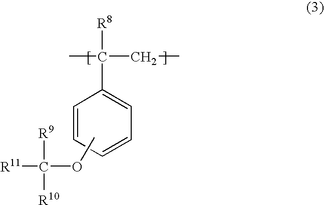

wherein R⁸ represents hydrogen or methyl, R⁹ and R¹⁰ each independently represents hydrogen, C1-6 alkyl, C3-6 cycloalkyl, C1-6 haloalkyl, C3-6 halocycloalkyl, or optionally substituted phenyl, or R⁹ and R¹⁰ bond to form C5-10 alkylene chain, R¹¹ represents C1-10 alkyl, C3-10 cycloalkyl, C1-10 haloalkyl, C3-10 halocycloalkyl or C7-12 aralkyl.

<11> The chemical amplification resist composition according to <1>,<2>,<3>, <4>,<6> or <10> wherein the resin (1) is Resin (b) and Resin (b) further comprises at least one repeating unit selected from the group consisting of a repeating unit of the formula (4) and a repeating unit of the following formula (5):

formula (4)

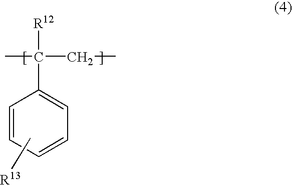

wherein R¹² represents hydrogen or methyl, R¹³ represents hydrogen, C1-4 alkyl, C1-8 alkoxy, C3-8 cycloalkyloxy or a group of the following formula (6),

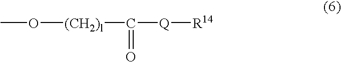

wherein R¹⁴ represents C1-8 alkyl, C6-C10 aryl or saturated heterocyclic group, Q represents single bond or oxygen, and 1 denote 0 or natural number, formula (5)

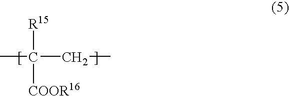

wherein R¹⁵ represents hydrogen, methyl or trifluoromethyl, and R¹⁶ represents hydrocarbon group having bonding site at primary or secondary carbon.

<12> The chemical amplification resist composition according to <1>,<2>,<3>, <4>,<6>,<10> or <11> wherein the Resin (1) is Resin (b) and the crude Resin (b) is a resin produced i) by living radical polymerization or living anion polymerization of protected hydroxystyrene, deprotection and re-protection, or ii) by radical polymerization of protected hydroxystyrene or protected hydroxystyrene and vinyl monomer, deprotection and re-protection.

<13> The chemical amplification resist composition according to any one of <1> to <12> which further comprises an amine.

<14> The chemical amplification resist composition according to any one of <1> to <13> wherein clogging degree of the composition is 0.9 or more when the composition is measured and calculated by the following definition.

Definition of Clogging Degree of Resist Composition

At 23° C., resist composition is poured into a filtration equipment in which a round and track-etch membrane filter (diameter: 47 mm, average pore size: 0.05 μm, thickness: 6 μm, pore density: 6×10⁸ pores/cm²) is set to a holder having volume of 300 ml, then pressure filtration is stared at a pressure of 100 kPa. The filtrate is collected in a receiver on a balance, and weight change of the filtrate is checked every one minute. Filtration time and accumulated weight of filtrate discharged are measured and linear velocity is calculated by dividing the weight of filtrate discharged per one minute by effective filter area. Maximum value of linear velocity reached in 10 minutes after starting the filtration is defined as V1 (the linear velocity at initial standard point). The linear velocity at the point the accumulated weight of filtrate discharged reaches to 15 g converted to the weight of solid components of the resist composition is measured and calculated in the same manner and is defined as V2. Clogging Degree is a value calculated by dividing V2 by V1.

<15> A process for producing a chemical amplification resist composition which comprises contacting crude resin (1) with activated carbon to obtain treated resin(1), and mixing the treated (meth)acrylic resin, an acid generator and an organic solvent, wherein the resin (1) is

(a) a (meth)acrylic resin which is insoluble or poorly soluble in an alkali aqueous solution and becomes soluble in an alkali aqueous solution by the action of an acid, and which comprises a repeating unit having an alicyclic hydrocarbon group in its side chain (hereinafter referred to as “Resin (a)”) or

(b) a styrenic resin which is insoluble or poorly soluble in an alkali aqueous solution and becomes soluble in an alkali aqueous solution by the action of an acid, and which comprises a repeating unit derived from hydroxystyrene (hereinafter referred to as “Resin (b)”).

<16> The process according to <15> wherein the resin (1) is Resin (a) and crude Resin (a) is produced by radical polymerization of a monomer having (meth)acrylic ester structure and leading to a repeating unit having an alicyclic hydrocarbon group in its side chain in an organic solvent selected from the group consisting of aromatic hydrocarbon, ether, glycol ether ester, ester, ketone and alcohol at a temperature of −50 to 100° C.

<17> The process according to <15> wherein the resin (1) is Resin (b) and crude Resin (b) is produced i) by living radical polymerization or living anion polymerization of protected hydroxystyrene, deprotection and re-protection, or ii) by radical polymerization of protected hydroxystyrene or protected hydroxystyrene and vinyl monomer, deprotection and re-protection.

### DESCRIPTION OF PREFERRED EMBODIMENTS

The present chemical amplification resist composition contains a treated resin (1) obtained by contacting crude resin (1) with activated carbon, an acid generator and a solvent.

Resin (1) is (a) a (meth)acrylic resin which is insoluble or poorly soluble in an alkali aqueous solution and becomes soluble in an alkali aqueous solution by the action of an acid, and which comprises a repeating unit having a alicyclic hydrocarbon group in its side chain or (b) a styrenic resin which is insoluble or poorly soluble in an alkali aqueous solution and becomes soluble in an alkali aqueous solution by the action of an acid, and which comprises a repeating unit derived from hydroxystyrene.

The “(meth)acrylic resin which is insoluble or poorly soluble in an alkali aqueous solution and becomes soluble in an alkali aqueous solution by the action of an acid, and which comprises a repeating unit having a alicyclic hydrocarbon group in its side chain” may hereinafter be referred to as “Resin (a)”, and the “styrenic resin which is insoluble or poorly soluble in an alkali aqueous solution and becomes soluble in an alkali aqueous solution by the action of an acid, and which comprises a repeating unit derived from hydroxystyrene” may hereinafter be referred to as “Resin (b)”

(A) Resin (a) “(meth)acrylic resin” means acrylic resin or methacrylic resin. “acrylic resin” means a polymer containing a repeating unit derived from acrylic acid or derivative thereof and “methacrylic resin” means a polymer containing a repeating unit derived from methacrylic acid or derivative thereof or a repeating unit derived from 2-(trifluoromethyl)acrylic acid or derivative thereof. “(meth)acrylic acid” means acrylic acid, methacrylic acid or 2-(trifluoromethyl)acrylic acid.

“repeating unit having alicylclic hydrocarbon group in its side chain” may hereinafter be referred to as “Alicyclic Repeating Unit”.

Examples of the alicyclic hydrocarbon group in Alicyclic Repeating Unit include 2-alkyl-2-adamantyl, 1-(1-adamantyl)-1-alkylalkyl, and such alicyclic hydrocarbon group forms a side chain itself or a part of a side chain connected to a main chain in a repeating unit. Alicyclic Repeating Unit is a repeating unit having a structure derived from vinyl monomer and having an alicyclic hydrocarbon group in its side chain. Examples of the structures derived from vinyl monomer include a structure derived from ester of (meth)acrylic acid and a structure derived from (meth)acrylamide, and the like.

As Alicyclic Repeating Unit, repeating units derived from ester of (met)acrylic acid are preferred, and in such cases, Y represents an alicyclic hydrocarbon group when the ester part in the structure derived from ester of (meth)acrylic acid is showed by —COOY. Specific examples thereof include a repeating unit derived from isobornyl acrylate, a repeating unit derived from isobornyl methacrylate, a repeating unit derived from isobornyl 2-(trifluoromethyl)acrylate, a repeating unit derived from 2-alkyl-2-adamantyl acrylate, a repeating unit derived from 2-alkyl-2-adamantyl methacrylate, a repeating unit derived from 2-alkyl-2-adamantyl 2-(trifluoromethyl)acrylate, a repeating unit derived from 1-(1-adamantyl)-1-alkylalkyl acrylate, a repeating unit derived from 1-(1-adamantyl)-1-alkylalkyl methacrylate, a repeating unit derived from 1-(1-adamantyl)1-alkylalkyl 2-(trifluoromethyl)acrylate, and the like. Examples of the esters of (meth)acrylic acid having alicyclic hydrocarbon group in its side chain include alicyclic hydrocarbyl ester of(meth)acrylic acid in which a tertiary carbon bonds to carboxyl group, such as 2-alkyl-2-adamantyl acrylate, 2-alkyl-2-adamantyl methacrylate, 2-alkyl-2-adamantyl 2-(trifluoromethyl)acrylate, 1-(1-adamantyl)-1-alkylalkyl acrylate, 1-(1-adamantyl)-1-alkylalkyl methacrylate, 1-(1-adamantyl)-1-alkylalkyl 2-(tifluoromethyl)acrylate, and the like; alicyclic hydrocarbyl ester of (meth)acrylic acid in which a primary or secondary carbon bonds to carboxyl group, such as isobornyl acrylate, isobornyl methacrylate, isobornyl 2-(trifluoromethyl)acrylate, 2-adamatyl acrylate, 2-adamantyl methacrylate, 2-adamantyl 2-(trifluoromethyl)acrylate, (1-adamantyl)methyl acrylate, (1-adamantyl)methyl methacrylate, (1-adamantyl)methyl 2-(trifluoromethyl)acrylate, 2-(1-adamantyl)ethyl methacrylate, 1-(1-adamantyl)ethyl 2-(tifluoromethyl)acrylate, and the like. “ester of (meth)acrylic acid in which a tertiary carbon bonds to carboxyl group” may hereinafter be referred to as “Tertiary Alicyclic (Meth)acrylate”, and “alicyclic hydrocarbyl ester of (meth)acrylic acid in which a primary or secondary carbon bonds to carboxyl group” may hereinafter be referred to as “Secondary Alicyclic (Meth)acrylate”.

Examples of (meth)acrylic resin including Alicyclic Repeating Unit includes polymers comprising repeating unit derived from ester of (meth)acrylic acid having alicyclic hydrocarbon group, especially include copolymers comprising repeating unit derived from ester of (meth)acrylic acid having alicyclic hydrocarbon group. When Alicyclic Repeating Unit is a repeating unit derived from Tertiary Alicyclic Meth)acrylate, homopolymer thereof may also be exemplified as the (meth)acrylic resin comprising Alicyclic Repeating Unit. When (meth)acrylic resin comprising Alicyclic Repeating Unit is a copolymer the content of Alicyclic Repeating Unit in Resin (a) is preferably 10% by mol or more, more preferably 30% by mol or more. When Resin (a) comprises a repeating unit derived from 2-alkyl-2-adamantyl (meth)acrylate or 1-(1-adamantyl)-1-alkylalkyl (meth)acrylate, the content of the repeating unit is advantageously 15% by mol or more.

Resin (a) is a resin which is insoluble or poorly soluble in an alkali aqueous solution and which becomes soluble in an alkali aqueous solution by the action of an acid.

Resin (a) contains a repeating unit having an acid labile group so as to be a resin which is insoluble or poorly soluble in an alkali aqueous solution and becomes soluble in an alkali aqueous solution by the action of an acid. Specifically, it contains a repeating unit having a group dissociated by the action of an acid.

Examples of the repeating units having a group dissociated by the action of an acid include repeating units derived from Tertiary Alicyclic (Meth)acrylate described above and repeating units having other carboxylate structure. When a part of ester in the other carboxylate structure is shown by —COOX, —OX represents a group dissociated by the action of an acid and X represents a residue of tertiary alcohol or a group represented by the formula —CH(R²)—OR³, wherein R² represents hydrogen or C1-5 alkyl, R³ represents C1-3 alkyl , (alicyclic hydrocarbyl)oxyalkyl or (alicyclic hydrocarbyl)carbonyloxyalkyl, or R² and R³ bond to form alkylene having 5 to 10 carbon atoms wherein at least one —CH2— in the alkylene other than the one connected to the adjacent —O— may be substituted by —O—. Specific examples thereof include a repeating unit of the formula (1)

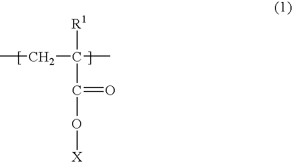

wherein R¹ represents hydrogen, methyl or trifluoromethyl, and X represents the same meaning above,

a repeating unit derived from ester of unsaturated alicyclic acid, and the like.

Examples of residues of tertiary alcohol include alicyclic hydrocarbon groups having a bonding site at a tertiary carbon such as 2-alkyl-2-adamantyl, 1-(1-adamantyl)-1-alkylalkyl, and the like; and tertiary alkyl such as tert.-butyl.

Examples of groups represented by —CH(R²)—OR³ include methoxymethyl, ethoxymethyl, 1-ethoxyethyl, 1-isobutoxyethyl, 1-isopropoxyethyl, 1-ethoxypropyl, 1-(2-methoxyethoxy)ethyl, 1-(2-acetoxyethyl)ethyl, 1-[2-1-adamantyloxy)ethoxy]ethyl, 1-[2-(adamantanecarbonyloxy)ethoxy]ethyl, tetrahydro-2-furyl, tetrahydro-2-pyranyl, and the like.

Monomers leading to repeating units having a group dissociated by the action of acid may be Tertiary Alicyclic (Meth)acrylate, other (meth)acrylates such as ester of methacrylic acid and ester of acrylic acid; and esters of unsaturated alicyclic carboxylic acids such as ester of norbomenecarboxylic acid, ester of tricyclodecenecarboxylic acid and ester of tetracyclodecenecarboxylic acid.

Among the monomers, monomers having bulky group such as alicyclic hydrocarbon group having a bonding site at a tertiary carbon are preferably used for better resolution of the resist composition obtained.

Examples of such monomers having bulky group include 2-alkyl-2-adamantyl (meth)acrylate, 1-(1-adamantyl)-1-alkylalkyl (meth)acrylate, 2-alkyl-2-adamantyl 5-norbornen-2-carboxylate, 1-(1-adamantyl)-1-alkylalkyl 5-norbornen-2-carboxylate, and the like.

Among them, 2-alkyl-2-adamantyl (meth)acrylate and 1-(1-adamantyl)-1-alkylalkyl (meth)acrylate are more preferred. They are monomers having a bulky group dissociated by the action of an acid as well as Tertiary Alicyclic (Meth)acrylate.

2-Alkyl-2-adamantyl (meth)acrylate is especially preferred for much better resolution. Examples of such 2-alkyl-2-adamantyl (meth)acrylate include 2-methyl-2-adamantyl acrylate, 2-methyl-2-adamantyl methacrylate, 2-ethyl-2-adamantyl acrylate, 2-ethyl-2-adamantyl methacrylate, 2-n-butyl-2-adamantyl acrylate, and the like. Among them, 2-ethyl-2-adamantyl (meth)acrylate is preferred for better balance of sensitivity and heat resisting property. If necessary, other monomers having a group dissociated by the action of an acid can be used together.

2-Alkyl-2-adamantyl (meth)acrylate can usually be produced by reacting 2-alkyl-2-adamantanol or metal salt thereof with an acrylic halide or methacrylic halide.

In addition to the above-mentioned repeating unit having a group dissociated by the action of an acid, Resin (a) used for the present composition can also contain other repeating units not dissociated or not easily dissociated by the action of an acid.

Examples of such other repeating units which can be contained include repeating units derived from unsaturated carboxylic acid such as acrylic acid and methacrylic acid, repeating units derived from aliphatic unsaturated dicarboxylic anhydrides such as maleic anhydride and itaconic anhydride, repeating unit derived from 2-norbornene, repeating unit derived from (meth)acrylonitrile, repeating units derived from various (meth)acrylates, and the like.

Particularly, to contain, in addition to the repeating unit having a group dissociated by the action of an acid, further at least one repeating unit selected from the group consisting of a repeating unit derived from 3-hydroxy-1-adamantyl (meth)acrylate, a repeating unit derived from 3,5-dihydroxy-1-adamantyl (meth)acrylate, a repeating unit derived from (meth)acryloyloxy-γ-butyrolactone wherein at least one hydrogen on the lactone ring may optionally be substituted by all, a repeating unit of the following formula (Ia) and a repeating unit of the following formula (Ib), in the resin in the present composition, is preferable from the standpoint of the adhesiveness of resist to a substrate.

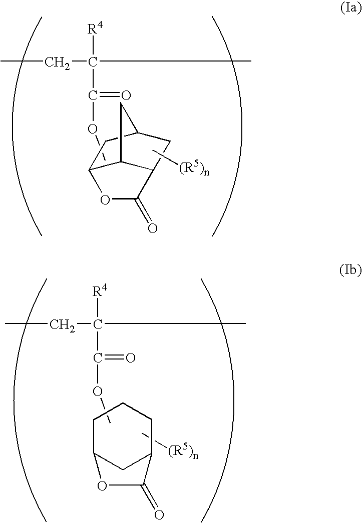

Here, R⁴ represents hydrogen, methyl or trifluoromethyl, R⁵ represents methyl or trifluoromethyl, n represents an integer of from 0 to 3, and when n is 2 or 3, each of R⁵ is the same or different.

3-Hydroxy-1-adamantyl (methacrylate and 3,5-dihydroxy-1-adamantyl (meth)acrylate can be produced, for example, by reacting corresponding hydroxyadamantane with (meth)acrylic acid or its acid halide, and they are also commercially available.

Further, (meth)acryloyloxy-γ-butyrolactone, wherein at least one hydrogen on the lactone ring may optionally be substituted by alkyl can be produced by reacting corresponding α- or β-bromo-γ-butyrolactone with acrylic acid or methacrylic acid, or reacting corresponding α- or β-hydroxy-γ-butyrolactone with acrylic halide or methacrylic halide.

As monomers leading to repeating units of the formulae (Ia) and (Ib), specifically listed are, for example, (meth)acrylates of alicyclic lactones having hydroxyl described below, and mixtures thereof, and the like. These esters can be produced, for example, by reacting corresponding alicyclic lactone having hydroxyl with (meth)acrylic acids, and the production method is described in, for example, JP2000-26446-A.

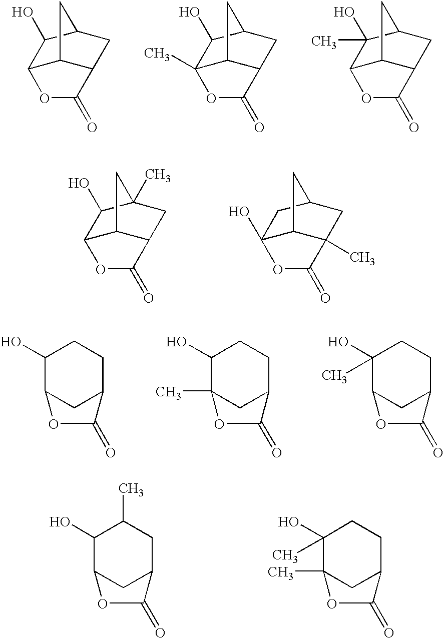

When any of the repeating unit derived from 3-hydroxy-1-adamantyl (meth)acrylate, the repeating unit derived from 3,5-dihydroxy-1-adamantyl (meth)acrylate, the repeating unit derived from α-(meth)acryloyloxy-γ-butyrolactone, the repeating unit derived from β-(meth)acryloyloxy-γ-butyrolactone and the repeating unit of the formulae (Ia) and (Ib) is contained in the resin, not only the adhesiveness of the resist to a substrate is improved, but also the resolution of the resist is improved.

Here, examples of the (meth)acryloyloxy-γ-butyrolactone include α-acryloyloxy-γ-butyrolactone, α-metacryloyloxy-γ-butyrolactone, α-acryloyloxy-β,β-dimethyl-γ-butyrolactone, α-methacryloyloxy-β,β-dimethyl-γ-butyrolactone, α-acryloylox-α-methyl-γ-butyrolactone, α-methacryloyloxy-α-methyl-γ-butyrolactone, β-acryloyloxy-γ-butyrolactone, β-methacryloyloxy-γ-butyrolactone, β-methacryloyloxy-α-methyl-γ-butyrolactone and the like.

When other repeating unit not dissociated or hardly dissociated by the action of an acid is contained, it is advantageous from the standpoint of dry etching resistance of the resist to contain 2-alkyl-2-adamantyl or 1-(1-adamantyl)-1-alkylalkyl as the acid labile group in the resin.

The resin containing a repeating unit derived from 2-norbornene shows strong structure because of alicyclic group directly present on its main chain and shows a property that dry etching resistance is excellent. The repeating unit derived from 2-norbornene can be introduced into the main chain by radical polymerization using, for example, in addition to corresponding 2-norbornene, aliphatic unsaturated dicarboxylic anhydrides such as maleic anhydride and itaconic anhydride together. The repeating unit derived from 2-norbornene is formed by opening of its double bond, and can be represented by the formula (II). The repeating unit derived from maleic anhydride and the repeating unit derived from itaconic anhydride which are the repeating unit derived from aliphatic unsaturated dicarboxylic anhydrides are formed by open of their double bonds, and can be represented by the formula (III) and the formula (IV), respectively.

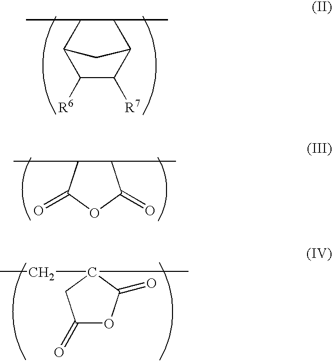

Here, R⁶ and R⁷ in the formula (II) each independently represent hydrogen, alkyl having 1 to 3 carbon atoms, hydroxyalkyl having 1 to 3 carbon atoms, carboxyl, cyano or —COOZ group in which Z represents alcohol residue, or R⁶ and R⁷ can bond together to form a carboxylic anhydride residue represented by —C(═O)OC(═O)—.

In R⁶ and R⁷, examples of the alkyl include methyl, ethyl, propyl and isopropyl, specific examples of hydroxyalkyl include hydroxymethyl, 2-hydroxyethyl and the like.

In R⁶ and R⁷, —COOZ group is an ester formed from carboxyl, and as the alcohol residue corresponding to Z, for example, optionally substituted alkyls having about 1 to 8 carbon atoms, 2-oxooxolan-3- or -4-yl and the like are listed, and as the substituent on the alkyl, hydroxyl, alicyclic hydrocarbon group and the like are listed

Specific examples of —COOZ include methoxycarbonyl, ethoxycarbonyl, 2-hydroxyethoxycarbonyl, tert-butoxycarbony, 2-oxooxalan-3-yloxycarbonyl, 2-oxooxalan-4-yloxycarbonyl, 1,1,2-trimethylpropoxycarbonyl, 1-cyclohexyl-1-methylethoxycarbonyl, 1-(4-methylcyclohexyl)-1-methylethoxycarbonyl, 1-(1-adamantyl)-1-methylethoxycarbonyl and the like.

Specific examples of the monomer used to lead to the repeating unit represented by the formula (II) may include the followings;

2-norbornene,

2-hydroxy-5-norbornene,

5-norbornen-2-carboxylic acid,

methyl 5-norbornen-2-carboxylate,

t-butyl 5-norbornen-2-carboxylate,

1-cyclohexyl-1-methylethyl 5-norbornen-2-carboxylate,

1-(4-methylcyclohexyl)-1-methylethyl 5-norbornen-2-carboxylate,

1-(4-hydroxycyclohexyl)-1-methylethyl 5-norbornen-2-carboxylate,

1-methyl-1-(4-oxocyclohexyl)ethyl 5-norbornen-2-carboxylate,

1-(1-adamantyl)-1-methylethyl 5-norbornen-2-carboxylate,

1-methylcyclohexyl 5-norbornen-2-carboxylate,

2-methyl-2-adamantyl 5-norbornen-2-carboxylate,

2-ethyl-2-adamantyl 5-norbornen-2-carboxylate,

2-hydroxyethyl 5-norbornen-2-carboxylate,

5-norbornen-2-methanol,

5-norbornen-2,3dicarboxylic acid anhydride, and the like.

When resin (1) is Resin (a), Resin (a) preferably contains repeating unit(s) having a group dissociated by the action of an acid generally in a ratio of 10 to 80% by mol in all structural units of the resin though the ratio varies depending on the kind of radiation for patterning exposure, the kind of a group dissociated by the action of an acid, and the like.

When, in addition to repeating units having an acid labile group, other repeating units not dissociated or not easily dissociated by the action of an acid, for example, a repeating unit derived from 3-hydroxy-1-adamantyl (meth)acrylate, a repeating units derived from 3,5-dihydroxy-1-adamantyl (meth)acrylate, repeating units derived from (meth)acryloyloxy-γ-butyrolactone, wherein at least one hydrogen on the lactone ring may optionally be substituted by alkyl, a repeating unit of the formula (Ia) or (Ib), a repeating unit derived from 2-norbornene of the formula (II), a repeating unit derived from maleic anhydride of the formula (III), a repeating unit derived from itaconic anhydride of the formula (I) and the like are contained, it is preferable that the sum of these repeating units is in the range of 20 to 90% by mol based on all repeating units of the resin.

When 2-norbornenes and aliphatic unsaturated dicarboxylic anhydride are used as copolymerization monomers, it is preferable to use them in excess amount in view of a tendency that these are not easily polymerized.

Crude Resin (a) used in the present invention can be produced, for example, by radical polymerization method. In the production of crude Resin (a), polymerization initiator is usually used. The amount of the polymerization initiator is usually 0.01 to 10 parts by weight based on 100 parts by weight of total monomers used in the production of Resin (a).

As polymerization initiators, thermal polymerization initiators and photo polymerization initiators can be used. Examples of the photo polymerization initiators include 2-hydroxy-4′-(2-hydroxyethoxy)-2-methylpropiophenone, and the like. Examples of the thermal polymerization initiators include azo compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), dimethyl 2,2′-azobis(2-methylpropionate), 2,2′-azobis(2-hydroxymethylpropionitrile), and the like; organic peroxides such as lauryl peroxide, tert-butyl hydroperoxide, benzoyl peroxide, tert-butyl peroxybenzoate, cumen hydroperoxide, diisopropyl peroxydicarbonate, di-n-propyl peroxydicarbonate, tert-butyl peroxyneodecanoate, tert-butyl peroxypivalate, (3,5,5-trimethylhexanoyl)peroxide, and the like; inorganic peroxides such as potassium persulfate, ammonium persulfate, hydrogen peroxide, and the like. Each of the polymerization initiators can be used alone or in combination with at least one other kind.

Further, chain transfer agents such as 1-butanethiol, 2-butanethiol, 1-octanethiol, 1-decanethiol, 1-tetradecanethiol, cyclohexanethiol, 2-methyl-1-propanethiol, and the like can be used in addition to the polymerization initiator above.

In the production of crude Resin (a), organic solvent are preferably the one which can dissolve monomers, initiator and crude Resin (a) obtained Examples of such organic solvents include aromatic hydrocarbons such as toluene, xylene, and the like; glycol ether esters such as ethyl Cellosolve acetate, propylene glycol monomethyl ether acetate, and the like; ethers such as tetrahydrofuran, 1,4-dioxane, and the like; esters such as ethyl lactate, ethyl acetate, butyl acetate, amyl acetate, ethyl pyruvate, γ-butyrolactone, and the like; ketones such as acetone, methyl ethyl ketone, methyl isobutyl ketone, 2-heptanone, cyclohexanone, and the like; alcohols such as n-propyl alcohol, isopropyl alcohol, and the like. Each of the organic solvent can be used alone or in combination with at least one other kind.

Specific example of the radical polymerization method in the production of crude Resin (a) include the method wherein a vinyl monomer having an alicyclic hydrocarbon group in its side chain, organic solvent, and if necessary, other monomer are mixed under nitrogen atmosphere and a polymerization initiator is added thereto, and the mixture is stirred usually at from −50 to 100° C., preferably at 30 to 90° C. usually for 3 to 10 hours. In the method above, a part of the monomers or polymerization initiator can be added during the reaction, or after the dissolution.

The weight average molecular weight of crude Resin (a) used in the present invention is preferably from 3000 to 100000, and more preferably from 5000 to 20000.

(8) Resin (b)

“styrenic resin” means a polymer containing a repeating unit derived from styrene or a derivative thereof.

Examples of the repeating units derived from hydroxystyrene include a repeating unit derived from p- or m-vinylphenol, a repeating unit derived from p- or m-hydroxy-α-methylstyrene, and the like. Examples of monomers leading to a repeating unit derived from hydroxystyrene include p- or m-vinylphenol, p- or m-hydroxy-α-methylstyrene, and the like.

Examples of the styrenic resin comprising a repeating units derived from hydroxystyrene include a polymer comprising a repeating unit derived from hydroxystyrene, specifically, a copolymer comprising a repeating unit derived from hydroxystyrene and at least one another repeating unit. The repeating unit derived from hydroxystyrene is preferably contained in an amount of 50% by mol or more, and more preferably of 70% by mol or more.

Resin (b) is not only a styrenic resin containing a repeating unit derived from hydroxystyrene, but also a resin which is insoluble or poorly soluble in an alkali aqueous solution and becomes soluble in an alkali aqueous solution by the action of an acid.

Resin (b) contains a repeating unit having an acid labile group so as to be a resin which is insoluble or poorly soluble in an alkali aqueous solution and becomes soluble in an alkali aqueous solution by the action of an acid. Specifically, it contains a repeating unit having a group dissociated by the action of an acid.

Examples of the repeating units having a group dissociated by the action of an acid include repeating units of the formula (1) above, repeating units of the formula (3)

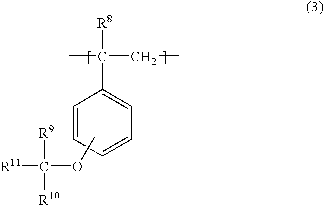

wherein R⁸ represents hydrogen or methyl, R⁹ and R¹⁰ each independently represents hydrogen, C1-6 alkyl, C3-6 cycloalkyl, C1-6 haloalkyl, C3-6 halocycloalkyl, or optionally substituted phenyl, or R⁹ and R¹⁰ bond to form C 5 to 10 alkylene chain, R¹¹ represents C1-10 alkyl, C3-C10 cycloalkyl, C1-10 haloalkyl, C3-C10 halocycloalkyl or C7-12 aralkyl.

In R⁹ and R¹⁰, examples of C1-6 alkyls include methyl, ethyl, n-propyl, isopropyl, n-butyl, isobutyl, tert-butyl, sec-butyl, n-pentyl, isopentyl, tert-pentyl, 1-methylpentyl, n-hexyl, isohexyl, and the like. Examples of C3-6 cycloalkyls include cyclopropyl, cyclopentyl, cyclohexyl, and the like. Examples of C1-6 haloalkyls and C3-6 halocycloalkyls include groups wherein at least one hydrogen in the groups exemplified above as C1-6 alkyl or C3-6 cycloalkyl is substituted with halogen such as fluorine, chlorine, bromine, iodine, and the like. Examples of the C5-10 alkylene chains formed by bonding R⁹ and R¹⁰ include pentamethylene, hexamethylene, octamethylene, and the like. Examples of optionally substituted phenyls include phenyl, p-tolyl, and the like.

In R¹¹, examples of C1-10 alkyls include methyl, ethyl, n-propyl, isopropyl, n-butyl, isobutyl, tert-butyl, sec-butyl, n-pentyl, isopentyl, tert-pentyl, 1-methylpentyl, n-hexyl, isohexyl, heptyl, octyl, nonyl, decyl, and the like. Examples of C3-10 cycloalkyls include cyclopropyl, cyclopentyl, cyclohexyl, and the like. Examples of C1-10 haloalkyls and C3-C10 halocycloalkyls include groups wherein at least one hydrogen in the groups exemplified above as C1-10 alkyl or C3-10 cycloalkyl is substituted with halogen such as fluorine, chlorine, bromine, iodine, and the like. Examples of C7-12 aralkyls include benzyl, phenetyl, phenylpropyl, methylbenzyl, methylphenethyl, ethylbenyl, and the like.

Examples of the monomers leading to repeating units of the formula (3) include p- or m-1-methoxy-1-methylethoxystyrene, p- or m-1-benyloxy-1-methylethoxystyrene, p- or m-1-benzyloxyethoxystyrene, p- or m-1-ethoxyethoxystyrene, p- or m-1-methoxyethoxystyrene, p- or m-1-n-butoxyethoxystyrene, p- or m-1-isobutoxyethoxystyrene, p- or m-1-(1,1-dimethylethoxy)-1-methylethoxystyrene, p- or m-1-(1,1-dimethylethoxy)ethoxystyrene, p- or m-1-(2-chloroethoxy)ethoxystyrene, p- or m-1-(2-ethylhexyloxy)ethoxystyrene, p- or m-1-ethoxy-1-methylethoxystyrene, p- or m-1-n-propoxyethoxystyrene, p or m-1-methyl-1-n-propoxyethoxystyrene, p- or m-1-methoxypropoxystyrene, p- or m-1-ethoxypropoxystyrene, p- or m-1-methoxybutoxystyrene, p- or m-1-methoxycyclohexyloxystyrene, p- or m-1-ethoxy-1-cyclohexylmethoxystyrene, p- or m-1-cyclohexyloxyethoxystyrene, p- or m-(α-ethoxybenzyl)oxystyrene, p- or m-[α-ethoxy-(4-methylbenzyl)]oxystyrene, p- or m-[α-ethoxy-(4-methoxybenzyl)]oxystyrene, p- or m-[α-ethoxy-(4bromobenzyl)]oxystyrene, p- or m-1-ethoxy-2-methylpropoxystyrene, and the like, and p- or m-hydroxy-α-methylstyrene derivatives having the same substituents as the p- or m-hydroxystyrene derivatives mentioned above, and the like.

Resin (b) may contain other repeating unit(s) in addition to the above repeating unit derived from hydroxystyrene and repeating unit having a group dissociated by the action of an acid. Examples thereof include a repeating unit of the following formula (4), repeating unit of the following formula (5), and the like Formula (4)

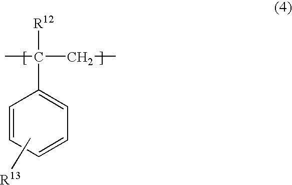

wherein R¹² represents hydrogen or methyl, R¹³ represents hydrogen, C1-4 alkyl, C1-8 alkoxy, C3-8 cycloalkyloxy or a group of the following formula (6),

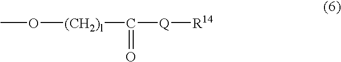

wherein R¹⁴ represents C1-8 alkyl, C6-10 aryl or saturated heterocyclic group, Q represents single bond or oxygen, and 1 denote 0 or natural number.

Formula (5)

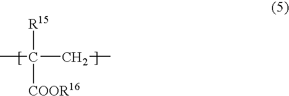

wherein R¹⁵ represents hydrogen, methyl or trifluoromethyl, and R⁶ represents hydrocarbon group having bonding site at a primary or secondary carbon.

In R¹³, examples of C1-4 alkyls include methyl, ethyl, n-propyl, isopropyl, n-butyl, isobutyl, tert-butyl and sec-butyl. Examples of C1-8 alkoxys include methoxy, ethoxy, n-propoxy, isopropoxy, n-butoxy, isobutoxy, tert-butoxy, sec-butoxy, n-pentyloxy, isopentyloxy, n-hexyloxy, isohexyloxy, n-heptyloxy, isoheptyloxy, n-octyloxy, tert-octyloxy, and the like. Examples of C3-8 cycloalkyloxys include cyclopropoxy, cyclopentyloxy, cyclohexyloxy, 1-methylcyclopentyloxy, 1-methylcyclohexyloxy, and the like.

In R¹⁴, examples of C1-8 alkyls include methyl, ethyl, n-propyl, isopropyl, n-butyl, isobutyl, tert-butyl, sec-butyl, n-pentyl, isopentyl, tert-pentyl, 1-methylpentyl, n-hexyl, isohexyl, heptyl, octyl, and the like. Examples of C3-8 cycloalkyls include cyclopentyl, 1-methylcyclopentyl, cyclohexyl, 1-methylcyclohexyl, and the like. Examples of saturated heterocyclic groups include tetrahydropyranyl, tetrahydrofuranyl, and the like Examples of C6-10 aryls include phenyl, 4-methylphenyl, 1-naphtyl, 2-naphtyl, and the like.

Specific examples of the groups of the formula (6) include methoxycarbonyloxy, ethoxycarbonyloxy, isopropoxycarbonyloxy, isobutoxycarbonyloxy, see butoxycarbonyloxy, tert-butoxycarbonyloxy, isopentyloxycarbonyloxy, tert-pentyloxycarbonyloxy, 1-methylcyclohexyloxycarbonylmethyloxy, 1-methylcyclopentyloxycarbonylmethyloxy, tetrahydropyranyloxycarbonylmethyloxy, tetrahydrofuranyloxycarbonylmethyloxy, tert-butoxycarbonylmethyloxy, acetyloxy, isobutanoyloxy, pivaloyloxy, isovaleroyloxy, cyclohexylcarbonyloxy, benzoyloxy, 4-methylbenzoyloxy, 1-naphthoyloxy, 2-naphthoyloxy, and the like.

Specific examples of the monomers leading to repeating units of the formula (4) includes styrene, p- or m-methylstyrene, p- or m-tert-butylstyrene, p- or m-methoxystyrene, p- or m-ethoxystyrene, p- or m-isopropoxystyrene, p- or m-tert-butoxystyrene, p- or m-cyclohexyloxystyrene, p- or m-1-methylcyclohexyoxystyrene, p- or m-1-methylcyclopentyloxystyrene, p- or m-tetrahydropyranyloxystyrene, p- or m-tetrahydrofuranyloxystyrene, p- or m-acetyloxystyrene, p- or m-isobutanoyloxystyrene, p- or m-pivaloyloxystyrene, p- or m-cyclohexylcarbonyloxystyrene, p- or m-benzoyloxystyrene, p- or m-(4-methylbenzoyl)oxystyrene, p- or m-1-naphthoyloxystyrene, p- or m-2-naphthoyloxystyrene, p- or m-methoxycarbonyloxystyrene, p- or m-ethoxycarbonyloxystyrene, p- or m-isopropoxycarbonyloxystyrene, p- or m-isobutoxycarbonyloxystyrene, p- or m-sec-butoxycarbonyloxystyrene, p- or m-tert-butoxycarbonyloxystyrene, p- or m-isopentyloxycarbonyloxystyrene, p- or m-tert-pentyloxycarbonyloxystyrene, ]-methylcyclopentyl p- or m-vinylphenoxyacetate. 1-methylcyclohexyl p- or m-vinylphenoxyacetate, tetrahydropyranyl p- or m-vinylphenoxyacetate, tert-butyl p- or m-vinylphenoxyacetate, and the like.

Specific examples of the monomers leading to repeating units of the formula (5) include methyl acrylate, ethyl acrylate, n-propyl acrylate, cyclohexyl acrylate, isobornyl acrylate, norbornyl acrylate, methyl methacrylate, ethyl methacrylate, n-propyl methacrylate, cyclohexyl methacrylate, isobornyl methacrylate, norbornyl methacrylate, and the like.

The repeating unit of the formula (4) and the repeating unit of the formula (5) can optionally be contained in Resin (b) for the purpose of obtaining better side wall shapes by controlling development speed on exposed portions, for the purpose of inhibiting influence by proximity effect and for the purpose of improving mask linearity.

Crude Resin (b) can be produced, for example, i) by living radical polymerization or living anion polymerization of protected hydroxystyrene, deprotection and re-protection, or ii) by radical polymerization of protected hydroxystyrene or protected hydroxystyrene and vinyl monomer, deprotection and re-protection.

In the case of living anion polymerization, protected polyhydroxystyrene can be obtained, for example, by dissolving a polymerization initiator in an organic solvent, adding thereto protected hydroxystyrene such as tert-butoxystyrene, and keeping the mixture under a dehydration condition at −100 to 0° C., preferably at −80 to −20° C.

Examples of polymerization initiators include organic metal compound such as sec-BuLi, n-BuLi, and the like. Examples of organic solvents include benzene, toluene, tetrahydrofuran, n-hexane, and the like.

Then, protected polyhydroxystyrene obtained is dissolved in organic solvent, deprotecting under acidic condition to obtain polyhydroxystyrene. Examples of the organic solvents include 2-propanol, dioxane, acetonitrile, toluene, methyl isobutyl ketone, and the like. Each of them can be used alone or in combination with at least one other kind. If solvent is miscible with water, solvent mixture with water can be used. Examples of acids include hydrochloric acid, hydrobromic acid, p-toluenesulfonic acid, and the like.

The polyhydroxystyrene obtained can be re-protected by a protecting agent to obtain crude Resin (b).

In the case of living radical polymerization, protected polyhydroxystyrene can be obtained, for example, by mixing free radical initiator, stable free radical acting agent and protected hydroxystyrene, then bulk polymerizing, solution polymerizing, suspension polymerizing, or emulsion polymerizing the mixture at usually from 100 to 180° C., preferably 110 to 140° C., usually for 5 to 50 hours, though the time depends on the degree of polymerization and the molecular weight

The free radical initiator may be the one produce free radical by decomposition, and specific examples thereof include peroxides such as benzoyl peroxide, di-tert-butyl peroxide, and the like, azo compounds such as 2,2′-azobisisobutyronitrile, dimethyl 2,2′-azobisisobutyrate, and the like.

The stable free radical acting agent is a compound being stably present in the form of free radical, and examples such radicals include nitroxide radical, hydrazinyl radical, and the like. Specific examples the stable free radical compounds include nitroxide such as 2,2,6,6-tetramethyl-1-piperidinyloxy (Trade Name:TEMPO), 4-amino2,2,6,6-tetramethyl-1-piperidinyloxy, 4hydroxy-2,2,6,6-tetramethyl-1-piperidinyloxy, 4-oxo-2,2,6,6-tetramethyl-1-piperidinyloxy, phenyl tert-butyl nitroxide, di-tert-butyl nitroxide, and the like,; 2,2-di(4-tert-octylphenyl)-1-picrylhydrazyl, and the like. Molar ratio of (the stable free radical acting agent)/(the free radical initiator) is preferably from 0.7 to 2, more preferably from 1 to 1.5.

Then, crude Resin (b) can be obtained by leading to poly(hydroxystyrene) by deprotection, and re-protecting polyhydroxystyrene by protecting agent in the same manner as in living anion polymerization.

In the case of radical polymerization, protected hydroxystyrene homopolymer or copolymer can be produced by polymerizing protected hydroxystyrene alone or monomer mixture of protected hydroxystyrene and vinyl monomer in the same manner as the production method for Resin (a) described above.

Then, crude Resin (b) can be obtained by leading to hydroxystyrene homopolymer or copolymer by deprotection, and re-protecting poly(hydroxystyrene) by protecting agent to obtain crude Resin (b) in the same manner as in living anion polymerization.

Resin (1) used for the present resist composition is the one obtained by contacting crude resin (1) above with activated carbon. “resin (1) obtained by contacting crude resin (1) with activated carbon” may hereinafter be referred to as “Treated Resin (1)”.

Specifically, Treated Resin (1) in the form of solution can be obtained by dissolving crude resin (1) in an organic solvent, contacting the solution with activated carbon, and eliminating the treated activated carbon.

Examples thereof include a method dissolving crude resin (1) in an organic solvent, contacting the solution with powdered or granular activated carbon by agitation for a determined period, and filtering off the treated activated carbon.

Crude resin (1) can be contacted with activated carbon by passing the crude resin (1) in the form of solution under pressure or by natural falling through a packed column filled with powdered activated carbon, granular activated carbon or both of them. Similarly, crude resin (1) can be contacted with activated carbon by passing the crude resin (1) in the form of solution under pressure or by natural falling through a filter bed consisting of a layer of powdered activated carbon, granular activated carbon or both of them on filter paper. When the packed column or filter bed is used for contacting with activated carbon, diatomaceous earth, and the like can be used together as filter aid. Contact can also be performed by passing crude resin (1) solution under pressure or by natural failing through a cartridge filled with activated carbon in a housing.

Examples of organic solvent used in the contact of crude resin (1) with activated carbon include glycol ether esters such as ethyl Cellosolve acetate, methyl Cellosolve acetate, propylene glycol monomethyl ether acetate, and the like; esters such as ethyl lactate, butyl acetate, amyl acetate, ethyl pyruvate, and the like; ketones such as acetone, methyl isobutyl ketone, 2-heptanone, cyclohexanone, and the like; cyclic esters such as γ-butyrolactone, and the like. The organic solvent can be used alone or in combination with at least one other kind It is preferred to use the same organic solvent as the one contained in the resist composition for simple preparation of the composition, The content of crude resin (1) in the solution is usually 1 to 50% by weight, preferably 20 to 30% by weight.

The activated carbon preferably has pore size of 10 to 50 Å, average diameter of 10 to 100 μm and specific surface area of 500 to 2000 m²/g. Examples thereof include “KARUBORAFIN” (trade name) and “SHIRASAGI P” (trade name) made by Takeda Chemical Co., Ltd..

The amount of activated carbon is preferably 0.01 to 100% by weight, more preferably 1 to 20% by weight based on crude resin (1).

The temperature of the contact of crude resin (1) with activated carbon is preferably 0 to 100° C. When crude resin (1) dissolved in an organic solvent and powdered or granular activated carbon is contacted by agitation, the contact period is usually 1 minute to 100 hours, preferably 2 to 6 hours.

The material of the filter used for eliminating the treated activated carbon may be the one has proper resisting property against the solvent used. Examples thereof include PTFE (polytetrafluoroethylene), polyethylene, polypropylene, and the like. Filtrating method may be natural filtration, pressure filtration, filtration under reduced pressure, centrifugal filtration, or the like.

When the treated activated carbon is eliminated by filter, filter aids can be used for improving filtration property. Examples thereof include diatomaceous earth such as radiolite, sellaite, and the like, silica gel, chemically modified type silica gel, and the like. The filter aid can be used alone or in combination with at least one other kind. The amount of filter aid is usually 0.01 to 100 parts by weight, preferably 0.1 to 10 parts by weight per one part by weight of activated carbon used.

The chemical amplification resist composition comprises Treated Resin (1), an acid generator and a solvent.

The acid generator is that which is decomposed to generate an acid by allowing radioactive ray such as light and electron beam to act on the acid generator itself or a resist composition containing the acid generator. The acid generated from the acid generator acts on resin (1), to dissociate acid labile group present in resin (1). Such acid generators include, for example, onium salt compounds, organic halogen compounds, sulfone compounds, sulfonate compounds and the like.

Specific examples of the acid generators include the following compounds. Diphenyliodonium trifluoromethanesulfonate,

4-methoxyphenylphenyliodinium hexafluoroantimonate,

4-methoxyphenylphenyliodinium trifluoromethanesulfonate,

bis(4-tert-butylphenyl)iodonium tetrafluoroborate,

bis(4-tert-butylphenyl)iodonium perfluorobutanesulfonate,

bis(4-tert-butylphenyl)iodonium hexafluorophosphate,

bis(4-tert-butylphenyl)iodonium hexafluoroantimonate,

bis(4-tert-butylphenyl)iodonium trifluoromethanesulfonate,

bis(4-tert-butylphenyl)iodonium camphorsulfonate,

triphenylsulfonium hexafluorophosplate,

triphenylsulfonium hexafluoroantimonate,

tiphenylsulfonium trifluoromethanesulfonate,

triphenylsulfonium perfluorobutanesulfonate,

triphenylsulfonium perfluorooctanesulfonate,

tri(4-methylphenyl)sulfonium trifluoromethanesulfonate,

tri(4-methylphenyl)sulfonium perfluorobutanesulfonate,

tri(4-methylphenyl)sulfonium perfluorooctanesulfonate,

4-methylphenyldiphenylsulfonium perfluorobutanesulfonate,

4-methylphenyldiphenylsulfonium hexafluoroantimonate,

4-methylphenyldiphenylsulfonium trifluoromethanesulfonate,

4methylphenyldiphenylsulfonium hexafluoroantimonate,

4-methylphenyldiphenylsulfonium trifluoromethanesulfonate,

p-tolyldiphenylsulfonium trifluoromethanesulfonate,

p-tolyldiphenylsulfonium perfluorobutanesulfonate,

p-tolyldiphenylsulfonium perfluorooctanesulfonate,

2,4,6-trimethylphenyldiphenylsulfonium trifluoromethanesulfonate,

4-tert-butylphenyldiphenylsulfonium trifluoromethanesulfonate,

4-phenylthiophenyldiphenylsulfonium hexafluorophosphate,

4-phenylthiophenyldiphenylsulfonium hexafluoroantimonate,

1-(2-naphtholylmethyl)thiolanium hexafluoroantimonate,

1-(2-naphtholylmethyl)thiolanium trifluoromethanesulfonate,

4-hydroxy-1-naphthyldimethylsulfonium hexafluoroantimonate,

4-hydroxy-1-naphthyldimethylsulfonium trifluoromethanesulfonate,

cyclohexylmethyl(2-oxocyclohexyl)sulfonium trifluoromethanesulfonate,

cyclohexylmethyl(2-oxocyclohexyl)sulfonium perfluorobutanesulfonate,

cyclohexylmethyl(2-oxycyclohexyl)sulfonium perfluorootcanesulfonate,

2-methyl-4,6-bis(trichloromethyl)-1,3,5-triazine,

2,4,6-tris(tichloromethyl)-1,3,5-triazine,

2-phenyl-4,6-bis(trichloromethyl)-1,3,5-triazine,

2-(4-chlorophenyl)-4,6-bis(trichloromethyl)-1,3,5-triazine,

2-(4-methoxyphenyl)-4,6-bis(tichloromethyl% 1,3,5-triazine,

2-(4-methoxy-1-naphthyl)-4,6-bis(trichloromethyl)-1,3,5-triazine,

2-(benzo[d][1,3]dioxolan-5-yl)-4,6-bis(trichloromethyl)-1,3,5-triazine,

2-(4-methylstyryl)-4,6-bis(tichloromethyl)-1,3,5-triazine,

2-(3,4,5-trimethoxystyryl)-4,6-bis(trichloromethyl)-1,3,5-triazine,

2-(3,4-dimethoxystyryl)-4,6-bis(trichloromethyl)-1,3,5-triazine,

2-(2,4-dimethoxystyryl)-4,6-bis(trichloromethyl)-1,3,5-triazine,

2-(2-methylstyryl)-4,6-bis(trichloromethyl)-1,3,5-triazine,

2-(4-butoxystyryl)-4,6-bis(trichloromethyl)-1,3,5-triazine,

2-(4-pentyloxystyryl)-4,6-bis(trichloromethyl)-1,3,5-triazine,

1-benzoyl-1-phenylmethyl p-toluenesulfonate (generally called “benzoin tosylate”),

2-benzoyl-2-hydroxy-2-phenylethyl p-toluenesulfonate (generally called

α-methylolbenzoin tosylate),

1,2,3-benzen-tri-yl tris(methanesulfonate),

2,6-dinitrobenzyl p-toluenesulfonate,

2-nitrobenzyl p-toluenesulfonate,

4-nitrobenzyl p-toluenesulfonate,

diphenyl disulfone,

di-p-tolyl disulfone,

bis(phenylsulfonyl)diazomethane,

bis(4-chlorophenylsulfonyl)diazomethane,

bis(p-tolylsulfonyl)diazomethane,

is(4-tert-butylphenylsulfonyl)diazomethane,

bis(2,4-xylylsulfonyl)diazomethane,

bis(cyclohexylsulfonyl)diazomethane,

(benzoyl)(phenylsulfonyl)diazomethane,

N-(phenylsulfonyloxy)succinimide,

N-(trifluoromethylsulfonyloxy)succinimide,

N-(tifluoromethylsulfonyloxy)phthalimide,

N-(trifluoromethylsulfonyloxy)-5-norbornene-2,3-dicarboxamide,

N-(trifluoromethylsulfonyloxy)naphthylamide,

N-(10-camphorsulfonyloxy)naphthalimide,

(5-propylsulfonyloxyimino-5H-thiophen-2-ylidene)-(2-methylphenyl)acetonitrile,

(5-(4-methylphenyl)sulfonyloxyimino-5H-thiophen-2-ylidene)-(2-methylphenyl)acetonitrile,

(5-butylsulfonyloxyimino-5H-thiophen-2-ylidene)-(2-methylphenyl)acetonitrile,

(5-n-octylsulfonyloxyimino-5H-thiophen-2-ylidene)-(2-methylphenyl)acetonitrile,

(5-(2,4,6-trimethylphenyl)sulfonyloxyimino-5H-thiophen-2-ylidene)-(2-methylphenyl) acetonitrile,

(5-(2,4,6-triisopropylphenyl)sulfonyloxyimino-5H-thiophen-2-ylidene(2-methylpheny

1)acetonitrile,

(5-(4-dodecylphenyl)sulfonyloxyimino-5H-thiophen-2-ylidene)-(2-methylphenyl)aceto nitrile,

(5-(2-naphtyl)sulfonyloxyimino5H-thiophen-2-ylidene)-(2-methylphenyl)acetonitrile,

(5-benzylsulfonyloxyimino-5H-thiophen-2-ylidene)-(2-methylphenyl)acetonitrile,

(oxydi-4,1-phenylene)bisdiphenylsulfonium bis(methanesulfonate),

(oxydi-4,1-phenylene)bisdiphenylsulfonium bis(benzenesulfonate),

(oxydi-4,1-phenylene)bisdiphenylsulfonium bis(p-toluenesulfonate),

(oxydi-4,1-phenylene)bisdiphenylsulfonium bis(camphorsulfonate),

(oxydi-4,1-phenylene)bisdiphenylsulfonium bis(triisopropylbenzenesulfonate),

(oxydi-4,1-phenylene)bisdiphenylsulfonium bis(pentafluorobenzenesulfonate),

(oxydi-4,1-phenylene)bisdiphenylsulfonium bis(trifluoromethanesulfonate),

(oxydi-4,1-phenylene)bisdiphenylsulfonium bis(perfluorobutanesulfonate),

(oxydi-4,1-phenylene)bisdiphenylsulfonium bis(perfluorooctanesulfonate),

(oxydi-4,1-phenylene)bisdiphenylsulfonium

bis{trifluoro-N-[(perfluoromethyl)sulfonyl]-1-methanesulfonamidate},

(oxydi-4,1-phenylene)bisdiphenylsulfonium

bis{perfluoro-N-[(perfluoroethyl)sulfonyl]-1-ethanesulfonamidate},

(oxydi4,1-phenylene)bisdiphenylsulfonium

bis{perfluoro-N-[(perfluorobutyl)sulfonyl]-1-butanesulfonamidate},

(oxydi-4,1-phenylene)bisdiphenylsulfonium

bis{trifluoro-N-[(perfluorobutyl)sulfonyl-]-1-methanesulfonamidate},

(oxydi-4,1-phenylene)bisdiphenylsulfonium bis(tetrafluoroborate),

(oxydi-4,1-phenylene)bisdiphenylsulfonium bis(hexafluoroarsenate),

(oxydi-4,1-phenylene)bisdiphenylsulfonium bis(hexafluoroantimonate),

(oxydi-4,1-phenylene)bisdiphenylsulfonium bis(hexafluoroarsenate),

(oxydi-4,1-phenylene)bisdi(4-tert-butylphenyl)sulfonium

bis(trifluoromethanesulfonate),

(oxydi4,1-phenylene)bisdi(4-tert-butylphenyl)sulfonium bis(perfluorobutanesulfonate),

(oxydi4,1-phenylene)bisdi(p-tolyl)sulfonium bis(trifluoromethanesulfonate),

triphenylsulfonium (adamantan-1-ylmethyl)oxycarbonyldifluoromethanesulfonate, and the like.

The solvent used in the present composition may be the one which sufficiently dissolve each ingredients, has an adequate drying rate, and gives a uniform and smooth coat after evaporation of the solvent Hence, solvents generally used in the art can be used.

Examples thereof include glycol ether esters such as ethyl Cellosolve acetate, methyl Cellosolve acetate, propylene glycol monomethyl ether acetate, and the like; esters such as ethyl lactate, butyl acetate, amyl acetate and ethyl pyruvate, and the like; ketones such as acetone, methyl isobutyl ketone, 2-heptanone, cyclohexanone; and the like; cyclic esters such as y-butyrolactone, and the like. These solvents can be used each alone or in combination of two or more.

In the present composition, performance deterioration caused by inactivation of acid which occurs due to post exposure delay can be diminished by adding basic compounds, particularly, basic nitrogen-containing organic compounds, for example, amines as a quencher.

Specific examples of such basic nitrogen-containing organic compounds include the ones represented by the following formulae:

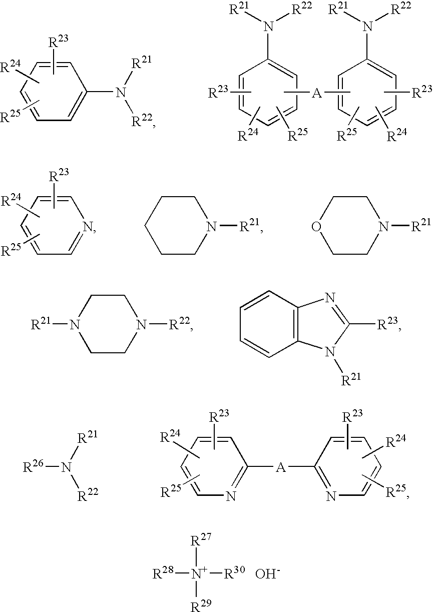

Wherein R²¹ and R²² represent each independently hydrogen, alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted by hydroxyl, amino, or alkoxy having 1 to 6 carbon atoms. At least one hydrogen on the amino may each independently be substituted by alkyl having 1 to 4 carbon atoms.

R²³, R²⁴ and R²⁵ each independently represent hydrogen, alkyl, cycloalkyl, aryl or alkoxy. The alkyl preferably has about 1 to 6 carbon atoms, the cycloalkyl preferably has about 5 to 10 carbon atoms, the aryl preferably has about 6 to 10 carbon atoms, and the alkoxy preferably has about 1 to 6 carbon atoms. Furthermore, at least one hydrogen on the alkyl, cycloalkyl, aryl or alkoxy may each independently be substituted by hydroxyl, amino, or alkoxy having 1 to 6 carbon atoms. At least one hydrogen on the amino may be substituted by alkyl having 1 to 4 carbon atoms.

R²⁶ represents alkyl or cycloalkyl. The alkyl preferably has about 1 to 6 carbon atoms, and the cycloalkyl preferably has about 5 to 10 carbon atoms. Furthermore, at least one hydrogen on the alkyl or cycloalkyl may each independently be substituted by hydroxyl, amino, or alkoxy having 1 to 6 carbon atoms. At least one hydrogen on the amino may be substituted by alkyl having 1 to 4 carbon atoms. R²⁷, R²⁸, R²⁹ and R³⁰ each independently represent alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted by hydroxyl, amino, or alkoxy having 1 to 6 carbon atoms. At least one hydrogen on the amino may each independently be substituted by alkyl having 1 to 4 carbon atoms.

A represents alkylene, carbonyl, imino, sulfide or disulfide. The alkylene preferably has about 2 to 6 carbon atoms.

Moreover, among R²¹-R³⁰, in regard to those which can be straight-chained or branched, either of these may be permitted.

Examples of such compounds include hexylamine, heptylamine, octylamine, nonylamine, decylamine, aniline, 2-, 3- or 4methylaniline, 4-nitroaniline, 1- or 2-naphtylamine, ethylenediamine, tetramethylenediamine, hexamethylenediamine, 4,4′-diamino-1,2-diphenylethane, 4,4′-diamino-3,3′-dimethyldiphenylmethane, 4,4′-diamino3,3′-diethyldiphenylmethane, dibutylamine, dipentylamine, dihexylamine, diheptylamine, dioctylamine, dinonylamine, didecylamine, N-methylaniline, piperidine, diphenylamine, triethylamine, trimethylamine, tripropylamine, tributylamine, triphenylamine, trihexylamine, trihexylamine, triheptylamine, trioctylamine, trinonylamine, tridodecylamine, methyldibutylamine, methyldipentylamine, methyldihexylamine, methyldicyclohexylamine, methyldipentylamine, methyldioctylamine, methyldinonylamine, methyldidecylamine, ethyldibutylamine, ethydipentylamine, ethyldihexylamine, ethydiheptylamine, ethyldioctylamine, ethyldinonylamine, ethyldidecylamine, dicyclohexylmethylamine, tris[2-(2-methoxyethoxy)ethyl]amine, triisopropanolamine, N,N-dimethylaniline, 2,6-isopropylaniline, imidazole, pyridine, 4-methylpyridine,4-methyimidazole, bipyridine, 2,2′-dipyridylamine, di-2-pyridyl ketone,1,2-di(2-pyridyl)ethane, 1,2-di(4-pyridyl)ethane,1,3-di(4-pyridyl)propane,1,2-bis(2-pyridyl)ethylene, 1,2-bis(4pyridyl)ethylene, 1,2-bis(4-pyridyloxy)ethane, 4,4′-dipyridyl sulfide, 4,4′-dipyridyl disulfide, 1,2-bis(4-pyridyl)ethylene, 2,2′-dipicolylamine, 3,3′-dipicolylamine, tetramethylammonium hydroxide, tetraisopropylammonium hydroxide, tetrabutylammonium hydroxide, tetra-n-hexylammonium hydroxide, tetra-n-octylammonium hydroxide, phenyltrimethylammonium hydroxide, 3-trifluoromethylphenyltrimethylammonium hydroxide, (2-hydroxyethyl)trimethylammonium hydroxide (so-called “choline”), and the like.

Furthermore, hindered amine compounds having piperidine skeleton as disclosed in JP-A-H11-52575 can be used as quencher.

It is preferable that the present composition contains Treated Resin (1) in an amount of about 80 to 99.9% by weight and the acid generator in an amount of 0.1 to 20% by weight based on the total weight of solid components of the present composition. The “total weight of solid components of resist composition” means the weight subtracting the weight of organic solvent from the weight of the resist composition.

When basic compound is used as a quencher, it is preferable that the basic compound is contained in an amount of about 0.01 to 1% by weight based on the total weight of solid components of the present composition.

The present composition can contain, if necessary, various additives in small amount such as a sensitizer, solution suppressing agent, other resins, surfactant, stabilizer, dye and the like, as long as the effect of the present invention is not prevented.

The present resist composition contains much fewer solvent-insoluble minute particles and has excellent filtration property through finer filter. The present resist composition usually has clogging degree of 0.9 or more when the composition is measured and calculated by the following definition.

Definition of Clogging Degree of Resist Composition

At 23° C., resist composition is poured into a filtration equipment in which a round and track-etch membrane filter (diameter: 47 mm, pore size: 0.05 μm, thickness: 6 μm, pore density: 6×10⁸ pores/cm²) is set to a holder having volume of 300 ml, then pressure filtration is started at a pressure of 100 kPa. The filtrate is collected in a receiver on a balance (weighing machine), and weight change of the filtrate is checked every one minute. Filtration time and accumulated weight of filtrate discharged are measured and linear velocity is calculated by dividing the weight of filtrate discharged per one minute by effective filter area. The linear velocity is a value showing filtration velocity (g/(cm² min.)) per 1 cm² of filter. Maximum value of linear velocity reached in 10 minutes after starting the filtration is defined as V1 (the linear velocity at initial standard point). The linear velocity at the point the accumulated weight of filtrate discharged reaches to 15 g converted to the weight of solid components of the resist composition is measured and calculated in the same manner and is defined as V2. Clogging Degree is a value calculated by dividing V2 by V1.

The track-etch membrane filter is a filter whose pores pass straight through the membrane from front surface to back surface. The membrane filter is made of polycarbonate.

The membrane filter for determining Clogging Degree is available and product name thereof is Nuclepore 0.05 μm 47 mm (importer; Nomura Micro Science Co., Ltd., Producer; Whatman Co., Ltd.).

The present resist composition thus obtained can be optionally filtrated before applying for resist, The filtration can be performed by the known filtration method and with known filter. Examples of the materials for filter include aliphatic polyamide, aromatic polyamide, polyethersulfone, polysulfone, polyacrylonitrile, polyimide, polyvinyl alcohol, polyvinylidene fluoride, cellulose, cellulose acetate, polyether, polytetrafluoroethylene, polycarbonate, polypropylene, polyethylene, polystyrene, polyester, ceramics, and the like. Among them, polyethylene, and polytetrafluoroethylene are preferred because of their solvent resisting property.

The present composition is to be applied onto a substrate such as a silicon wafer by a conventional process such as spin coating.

A resist film applied onto the substrate and then dried is subjected to exposure for patterning, then heat-treated for facilitating a deblocking reaction, and thereafter developed with an alkali developer. The alkali developer used here may be any one of various alkali aqueous solutions used in the art and generally, an aqueous solution of tetramethylammonium hydroxide or (2-hydroxyethyl)trimethylammonium hydroxide (commonly known as “choline”) is often used.

The present invention will be described more specifically by way of examples, which are not construed to limit the scope of the present invention. The “%” and “part(s)” used to represent the content of any component and the amount of any material used in the following examples are on a weight basis unless otherwise specifically noted. The weight-average molecular weight of any material used in the following examples is a value found by gel permeation chromatography using styrene as a standard reference material.

Resin Synthesis Example 1 (Synthesis of Resin A)

Into a four necked flask with replacing air by nitrogen, 2-ethyl-2-adamantyl methacrylate, 3-hydroxy-1-adamantyl methacrylate and 5-acryloyloxy-2,6-norbornanecarbolactone were charged at a molar ratio of 5:2.5:2.5 (20.0 parts:9.5 parts:7.3 parts), and methyl isobutyl ketone in twice weight based on all monomers was added, to prepare solution. To the solution was added azobisisobutyronitrile as an initiator in a ratio of 3.0% by mol based on all monomer molar amount, and the mi was heated at 80° C. for about 8 hours. Then, the reaction solution was poured into large amount of heptane to cause precipitation, and this operation was repeated free times, and then, the precipitate was dried. As a result, copolymer having a weight-average molecular weight of about 9,000 was obtained. This is called crude resin A.

Resin Synthesis Example 2 (Synthesis of Resin B)

(1) 350 g of poly(hydroxystyrene) [produced by living anion polymerization method, Weight-average molecular weight (Mw): 19000, Dispersion (Mw/Mn): 1.08] (2912 mmol calculated by using molecular weight of repeating unit derived from hydroxystyrene ) and 0.053 g of p-toluenesulfonic acid monohydrate were dissolved in 2100 g of methyl isobutyl ketone. Into this solution was dropped 116.64 g of isobutyl vinyl ether for 30 minutes. After stirred at 21° C. for 90 hours, into the stirred mixture was added 0.062 g of triethylamine and the mixture was stirred for several minutes. Then, to this were added 700 g of methyl isobutyl ketone and 525 g of ion-exchanged water and the mixture was stirred for washing. Then, the washed mixture was allowed to stand still for liquid separation to take out an organic layer portion. To the organic layer was added again 525 g of ion-exchanged water, and washing and liquid separation were conducted in the same manner as above. The washings and liquid separations were repeated tree more time. Then the organic layer obtained was concentrated by evaporating 2206 g of solvent, then, to the concentrate was added 3266 g of propylene glycol monomethyl ether acetate. The solution was concentrated by evaporating 3233 g of solvent to obtain 1332 g of 29% isobutoxyethylated poly p-hydroxystyrene solution (total weight of solid components: 32.9%) was obtained. The rate of isobutoxyethylation in hydroxyl group in poly(hydroxystyrene) was analyzed by ¹HNMR.

(2) 100 g of poly(hydroxystyrene) [produced by living anion polymerization method, Weight-average molecular weight (Mw);19000, Dispersion (Mw/Mn): 1.08] (832 mmol calculated by using molecular weight of repeating unit derived from hydroxystyrene ) and 0.016 g of p-toluenesulfonic acid monohydrate were dissolved in 600 g of methyl isobutyl ketone. Into this solution was dropped 19.4 g of isobutyl vinyl ether for 30 minutes. After stirred at 21° C. for 3 hours, into the stirred mixture was added 0.034 g of triethylamine and the mixture was stirred for several minutes. Then, to this were added 200 g of methyl isobutyl ketone and 150 g of ion-exchanged water and the mixture was stirred for washing. Then, the washed mixture was allowed to stand still for liquid separation to take out an organic layer portion. To the organic layer was added again 150 g of ion-exchanged water, and washing and liquid separation were conducted in the same manner as above. The washings and liquid separations were repeated three more time. Then, the organic layer obtained was concentrated by evaporating 581 g of solvent, then, to the concentrate was added 944 g of propylene glycol monomethyl ether acetate. The solution was concentrated by evaporating 888 g of solvent to obtain 393 g of 30% ethoxyethylated poly p-hydroxystyrene solution (total weight of solic components: 30.0%) was obtained. The rate of ethoxyethylation in hydroxyl group in poly(hydroxystyrene) was analyzed by ¹HNMR.

(3) Reaction and washings and liquid separations were conducted in the same manner as (2) above except that the amount of ethoxy vinyl ether was changed to 282 g to obtain washed organic layer.

Then, the organic layer obtained was concentrated by evaporating 576 g of solvent, then, to the concentrate was added 983 g of propylene glycol monomethyl ether acetate. The solution was concentrated by evaporating 924 g of solvent to obtain 409 g of 42% ethoxyethylated polyp-hydroxystyrene) solution (total weight of solic components: 30.0%) was obtained. he rate of ethoxyethylation in hydroxyl group in poly(hydroxystyrene) was analyzed by ¹HNMR.

(4) 16.82 g of 29% isobutoxyethylated poly p-hydroxystyrene solution, 34.11 g of 30% ethoxyethylated poly p-hydroxystyrene solution and 81.88 g of 42% ethoxyethylated poly(p-hydroxystyrene) solution were charged and mixed to obtain resin solution. This is called crude resin B.

### EXAMPLE 1

25 Parts of the crude resin A obtained in Synthetic Example 1 was dissolved in 75 parts of 2-heptanone. To the solution was added 2.5 parts of activated carbon (Trade Name: CARBORAFIN, pore size: 30 Å, specific surface area: 1500 m²/g ) and the mixture was stirred for 4 hours. Then, the treated mixture was filtrated by pressure filtration using 5 μm filter made of polytetrafluoroethylene to obtain treated resin A solution.

10 Parts of treated resin A (converted to total weight of solid components), 0.25 parts of (4-methylphenyl)diphenylsulfonium perfluorobutanesulfonate, and 0.010 part of 2,6-diisopropylaniline were dissolved in a mixed solvent of 27.1 parts of propylene glycol monomethyl ether acetate, 27.1 parts of 2-heptanone (including a portion from resin solutions) and 2.9 parts of γ-butyrolactone to obtain resist composition. The composition was filtrated by 0.2 μm filter made of PTFE (polytetrafluoroethylene) and 0.1 mm filter made of UPE (Ultra High Molecular Weight Polyethylene) both produced by Nihon Mykrolis K.K. to obtain a preliminary filtered resist composition.

The preliminary filtered resist composition above was evaluated the following items. The results are shown in Table 1.

Measurement of Clogging Degree

At 23° C., the preliminary filtered resist composition is poured into a filtration equipment in which a round and track-etch membrane filter (imported by Nomura micro Science Co., Ltd., diameter: 47 mm, pore size: 0.05 μm, thickness: 6 μm, pore density: 6×10⁸ pores/cm²) made of polycarbonate is set to a holder having volume of 100 ml made of stainless steel (produced by Nihon Mykrolis K.K.), then pressure filtration is started at a pressure of 100 kPa. The filtrate is collected on a balance (weighing machine), and weight change of the filtrate is checked every one minute. Filtration time and accumulated weight of filtrate discharged is measured and linear velocity is calculated by dividing the weight of filtrate discharged per one minute by effective filter area of 10.8 cm². Maximum value of linear velocity reached in 10 minutes after starting the filtration is defined as V1 (the linear velocity at initial standard point). The linear velocity at the point the accumulated weight of filtrate discharged reaches to 100 g (15 g converted to total weight of solid components) is measured and calculated in the same manner and is defined as V2. Clogging Degree is a value calculated by dividing V2 by V1.

Number of Minute Particles

Using an automatic minute particle analyzer (KS-41 Type, produced by Lion Co., Ltd.), number of particles having diameter of 0.2 μm or more was measured.

Number of Defects on Substrate

Using a wafer defect analyzer (KLA, produced by KLA Tencall Co., Ltd.), number of defects at coating film was measured. In table 1,“◯” means the number was less than 10, “Δ” means the number was 10 to 100, and “X” means the number was more than 100.

### EXAMPLE 2

159.4 Parts of the crude resin B obtained in Synthetic Example 2 was dissolved in 293 parts of propylene glycol monomethyl ether acetate. To the solution was added 2.5 parts of activated carbon (Trade Name: CARBORAFIN, pore size. 30 Å, specific surface area: 1500 m²/g) and the mixture was stirred for 4 hours. Then, the treated mixture was filtrated by pressure filtration using 5 μm filter made of polytetrafluoroethylene to obtain treated resin B solution.

13.5 Parts of treated resin B (as weight converted to total weight of solid components), 0.5 part of bis(cyclohexylsulfonyl)diazomethane, 0.2 part of 4-methylphenyldiphenylsulfonium tosylate, 0.01 part of N-methyldicyclohexylamine, 0.005 part of tetramethylammonium hydroxide, 0.135 part of polypropylene glycol 1000, 0.011 part of succimide, 0.15 part of dimethyl hydantoin and 0.15 part of dimethylimidazolidinone were dissolved in a mixed solvent of 113.0 parts of propylene glycol monomethyl ether acetate(including a portion from resin solutions), and 3.2 parts of γ-butyrolactone to obtain resist composition. The composition was filtrated by 0.1 μm filter made of PTFE (polytetrafluoroethylene) and 0.05 mm filter made of UPE (Ultra High Molecular Weight Polyethylene) both produced by Nihon Mykcrolis K.K. to obtain a preliminary filtered resist composition.

The preliminary filtered resist composition above was evaluated the same items as Example 1 in the same manner. The results are shown in Table 1.

### COMPARATIVE EXAMPLE 1

Experiment and evaluation were conducted in the same manner as in Example 1 except the treated resin A was changed to the crude resin A. The results are shown in Table 1.

### COMPARATIVE EXAMPLE 2

Experiment and evaluation were conducted in the same manner as in Example 2 except the treated resin B was changed to the crude resin B. The results are shown in Table 1.

TABLE 1

| | Ex. 1 | Ex. 2 | Comp. Ex. 1 | Comp. Ex. 2 |
|---|---|---|---|---|
| Clogging | 1.0 | 0.9 | 0.0 | 0.7 |
| Degree | | | | |
| Number of | 87 | 352 | 165 | 420 |
| minute particles | | | | |
| >0.2 μm/ml | | | | |
| Number of | ◯ | ◯ | X | Δ |
| Defects | | | | |

The present resist composition has excellent filtration property. When the present resist composition is used for the resist, the number of defect on silicon wafer can be remarkably decreased. Therefore, its industrial value is outstanding.

What is claimed is:

1. A chemical amplification resist composition comprising a treated resin (1) obtained by contacting crude resin (1) with activated carbon, an acid generator and a solvent,
wherein resin (1) is
(a) a (meth)acrylic resin which is insoluble or poorly soluble in an alkali aqueous solution and becomes soluble in an alkali aqueous solution by the action of an acid, and
which comprises a repeating unit having an alicyclic hydrocarbon group in its side chain (hereinafter referred to as “Resin (a)”) or
(b) a styrenic resin which is insoluble or poorly soluble in an alkali aqueous solution and becomes soluble in an alkali aqueous solution by the action of an acid, and which comprises a repeating unit derived from hydroxystyrene (hereinafter referred to as “Resin (b)”).

2. The chemical amplification resist composition according to claim 1, wherein the resin (1) contains a repeating unit having acid labile group.

3. The chemical amplification resist composition according to claim 2, wherein the repeating unit having acid labile group is a repeating unit having a group dissociated by the action of an acid.

4. The chemical amplification resist composition according to claim 3, wherein the content of the repeating unit having a group dissociated by the action of an acid in the resin (1) is 10 to 80% by mol.

5. The chemical amplification resist composition according to claim 1, wherein the resin (1) is Resin (a) and the repeating unit having a alicyclic hydrocarbon group in its side chain is at least one repeating unit selected from the group consisting of a repeating unit derived from 2-alkyl-2-adamantyl (meth)acrylate and a repeating unit derived from 1-(1-adamantyl)-1-alkylalkyl.

6. The chemical amplification resist composition according to claim 3, wherein the repeating unit having a group dissociated by the action of an acid is a repeating unit of the formula (1) 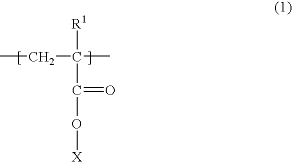
wherein R¹ represents hydrogen, methyl or trifluoromethyl, and X represents a residue of tertiary alcohol or a group represented by the formula of —CH(P²)—OR³, wherein R² represents hydrogen or C1-5 alkyl, R³ represents C1-3 alkyl, (alicyclic hydrocarbyl)oxyalkyl or (alicyclic hydrocarbyl)carbonyloxyalkyl, or R² and R³ bond to form alkylene having 5 to 10 carbon atoms wherein at least one —CH2— in the alkylene other than the —CH²— connected to the adjacent —O— may be substituted by —O—.

7. The chemical amplification resist composition according to claim 1 wherein the resin (1) is Resin (a) and Resin (a) further comprises at least one repeating unit selected from the group consisting of a repeating unit derived from 3-hydroxy-1-adamantyl (meth)acrylate, a repeating unit derived from 3,5-dihydroxy-1-adamantyl (meth)acrylate, a repeating unit derived from (meth)acryloyloxy-γ-butyrolactone wherein at least one hydrogen on the lactone ring may optionally be substituted by alkyl, a repeating unit of the following formula (Ia) and a repeating unit of the following formula (Ib): 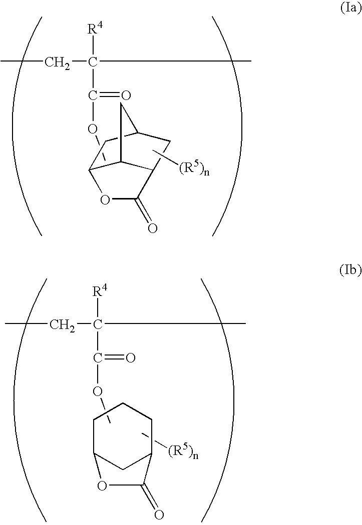
wherein R⁴ represents hydrogen, methyl or trifluoromethyl, R⁵ represents methyl or trifluoromethyl, n represents an integer of from 0 to 3, and when n is 2 or 3, each of R⁵ is the same or different.

8. The chemical amplification resist composition according to claim 1 wherein the resin (1) is Resin (a) and Resin (a) further comprises at least one repeating unit selected from the group consisting of a repeating unit derived from an aliphatic unsaturated dicarboxylic anhydride and a repeating unit derived from 2-norbornene.

9. The chemical amplification resist composition according to claim 1 wherein the resin (1) is Resin (a) and the crude Resin (a) is a resin produced by radical polymerization of a monomer having (meth)acrylic ester structure and leading to a repeating unit having an alicyclic hydrocarbon group in its side chain in an organic solvent selected from the group consisting of aromatic hydrocarbon, ether, glycol ether ester, ester, ketone and alcohol at a temperature of −50 to 100° C.

10. The chemical amplification resist composition according to claim 3 wherein the resin (1) is Resin (b) and the repeating unit having a group dissociated by the action of an acid is a repeating unit of the formula (3) 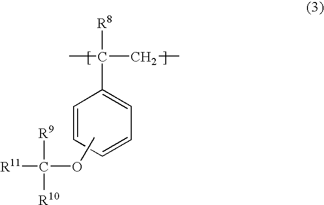
wherein R⁸ represents hydrogen or methyl, R⁹ and R¹⁰ each independently represents hydrogen, C1-6 alkyl, C3-6 cycloalkyl, C1-6 haloalkyl, C3-6 halocycloalkyl, or optionally substituted phenyl, or R⁹ and R¹⁰ bond to form C5-10 alkylene chain, R¹¹ represents C1-10 alkyl , C3-10 cycloalkyl, C1-10 haloalkyl, C3-10 halocycloalkyl or C7-12 aralkyl.

11. The chemical amplification resist composition according to claim 1 wherein the resin (1) is Resin (b) and Resin (b) further comprises at least one repeating unit selected from the group consisting of a repeating unit of the formula (4) and a repeating unit of the following formula (5):
formula (4) 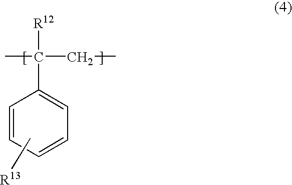
wherein R¹² represents hydrogen or methyl, R¹³ represents hydrogen, C1-4 alkyl, C1-8 alkoxy, C3-8 cycloalkyloxy or a group of the following formula (6), 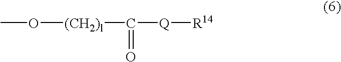
wherein R¹⁴ represents C1-8 alkyl, C6-10 aryl or saturated heterocyclic group, Q represents single bond or oxygen, and 1 denote 0 or natural number, formula (5) 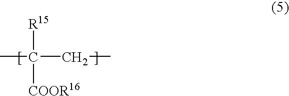
wherein R¹⁵ represents hydrogen, methyl or trifluoromethyl, and R¹⁶ represents hydrocarbon group having bonding site at primary or secondary carbon.

12. The chemical amplification resist composition according to claim 1 wherein the Resin (1) is Resin (b) and the crude Resin (b) is a resin produced i) by living radical polymerization or living anion polymerization of protected hydroxystyrene, deprotection and re-protection, or ii) by radical polymerization of protected hydroxystyrene or protected hydroxystyrene and vinyl monomer, deprotection and re-protection.

13. The chemical amplification resist composition according to claim 1 which further comprises an amine.

14. The chemical amplification resist composition according to claim 1 wherein clogging degree of the composition is 0.9 or more when the composition is measured and calculated by the following definition.
Definition of Clogging Degree of Resist Composition
At 23° C., resist composition is poured into a filtration equipment in which a round and track-etch membrane filter (diameter: 47 mm, average pore size: 0.05 μm, thickness: 6 μm, pore density: 6×10⁸ pores/cm²) is set to a holder having volume of 300 ml, then pressure filtration is started at a pressure of 100 kPa. The filtrate is collected in a receiver on a balance, and weight change of the filtrate is checked every one minute. Filtration time and accumulated weight of filtrate discharged are measured and linear velocity is calculated by dividing the weight of filtrate discharged per one minute by effective filter area. Maximum value of linear velocity reached in 10 minutes after starting the filtration is defined as V1 (the linear velocity at initial standard point). The linear velocity at the point the accumulated weight of filtrate discharged reaches to 15 g converted to the weight of solid components of the resist composition is measured and calculated in the same manner and is defined as V2. Clogging Degree is a value calculated by dividing V2 by V1.

15. A process for producing a chemical amplification resist composition which comprises contacting crude resin (1) with activated carbon to obtain treated resin(1), and mixing the treated (meth)acrylic resin, an acid generator and an organic solvent,
wherein the resin (1) is
(a) a (meth)acrylic resin which is insoluble or poorly soluble in an alkali aqueous solution and becomes soluble in an alkali aqueous solution by the action of an acid, and
which comprises a repeating unit having an alicyclic hydrocarbon group in its side chain (hereinafter referred to as “Resin (a)”) or
(b) a styrenic resin which is insoluble or poorly soluble in an alkali aqueous solution and becomes soluble in an alkali aqueous solution by the action of an acid, and which
comprises a repeating unit derived from hydroxystyrene (hereinafter referred to as “Resin (b)”).

16. The process according to claim 15 wherein the resin (1) is Resin (a) and crude Resin (a) is produced by radical polymerization of a monomer having (meth)acrylic ester structure and leading to a repeating unit having an alicyclic hydrocarbon group in its side chain in an organic solvent selected from the group consisting of aromatic hydrocarbon, ether, glycol ether ester, ester, ketone and alcohol at a temperature of −50 to 100° C.

17. The process according to claim 15 wherein the resin (1) is Resin (b) and crude Resin (b) is produced i) by living radical polymerization or living anion polymerization of protected hydroxystyrene, deprotection and re-protection, or ii) by radical polymerization of protected hydroxystyrene or protected hydroxystyrene and vinyl monomer, deprotection and re-protection.
